(19) United States
(12) Patent Application Publication
(10) Pub. No.: US 2019/0012000 A1
(43) Pub. Date: Jan. 10, 2019

(54) Deformable Electronic Device with Methods and Systems for Controlling the Deformed User Interface

(71) Applicant: Motorola Mobility LLC, Chicago, IL (US)

(72) Inventors: Alberto Cavallaro, Northbrook, IL (US); Ryan Kimball, Chicago, IL (US); Sharma Shankar Anandane, East Palo Alto, CA (US); Karina Sirota, Long Grove, IL (US)

(21) Appl. No.: 15/642,184

(22) Filed: Jul. 5, 2017

(51) Int. Cl. G06F 3/0346; G06F 3/044; G06F 1/16; G06F 3/0481

(52) U.S. Cl. CPC G06F 3/0346; G06F 3/044; G06F 1/1652; G06F 2203/04801; G06F 2203/04102; G06F 2203/04803; G06F 3/04812

(57) ABSTRACT

An electronic device includes a deformable housing and a flexible display supported by the deformable housing. The flexible display can be touch-sensitive, and can include a touch sensor. One or more flex sensors detect when the electronic device is deformed at a deformation location. One or more processors, operable with the flexible display and the one or more flex sensors, then detect user input along a first portion of the flexible display disposed to a first side of the deformation location, and control a second portion of the flexible display disposed to a second side of the deformation location as a function of the user input.

### BACKGROUND

### Technical Field

This disclosure relates generally to electronic devices and corresponding methods, and more particularly to physically deformable electronic devices.

### Background Art

Mobile electronic communication devices, such as smartphones, are used by billions of people. These users employ mobile communication devices for many different purposes including, but not limited to, voice communications and data communications for text messaging, Internet browsing, commerce such as banking, and social networking.

As the technology of these devices has advanced, so too has their feature set. For example, not too long ago all electronic devices had physical keypads. Today touch sensitive displays are more frequently seen as user interface devices. Today some devices are even equipped with voice recognition that allows a user to speak commands to a device instead of typing them.

As the technology evolves, conventional techniques for manipulating, controlling, and otherwise interacting with improved electronic devices is sometimes inefficient, tedious, and cumbersome. It would be advantageous to have improved control and usage modes for electronic devices that are able to adapt performance to a given environment, condition, or application.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates both an explanatory electronic device and an explanatory schematic block diagram of the electronic device in accordance with one or more embodiments of the disclosure.

FIG. 2 illustrates a sectional view of one explanatory electronic device in accordance with one or more embodiments of the disclosure.

FIG. 3 illustrates a user manipulating one explanatory electronic device in accordance with one or more embodiments of the disclosure to execute a bending operation to deform the explanatory electronic device.

FIG. 4 illustrates one explanatory electronic device having a flexible display that is deformed by one or more bends in accordance with one or more embodiments of the disclosure.

FIG. 5 illustrates one explanatory electronic device having a flexible display that is deformed by one or more bends in accordance with one or more embodiments of the disclosure.

FIG. 6 illustrates one explanatory electronic device in a deformed physical configuration in accordance with one or more embodiments of the disclosure.

FIG. 7 illustrates a method of manipulating content on a first portion of a deformed display of an explanatory electronic device by interacting with a second portion of a deformed display in accordance with one or more embodiments of the disclosure.

FIG. 8 illustrates a method of manipulating content on a first portion of a deformed display of an explanatory electronic device by interacting with a second portion of a deformed display in accordance with one or more embodiments of the disclosure.

FIG. 9 illustrates a method of manipulating content on a first portion of a deformed display of an explanatory electronic device by interacting with a second portion of a deformed display in accordance with one or more embodiments of the disclosure.

FIG. 10 illustrates a method of manipulating content on a first portion of a deformed display of an explanatory electronic device by interacting with a second portion of a deformed display in accordance with one or more embodiments of the disclosure.

FIG. 11 illustrates a method of controlling a deformed electronic device in accordance with one or more embodiments of the disclosure.

FIG. 12 illustrates a method of controlling a deformed electronic device in accordance with one or more embodiments of the disclosure.

FIG. 13 illustrates one explanatory method in accordance with one or more embodiments of the disclosure.

FIG. 14 illustrates one explanatory method in accordance with one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to controlling, manipulating, or actuating content or user actuation targets presented on one portion of a deformed touch-sensitive display by interacting with another portion of the deformed touch-sensitive display. Any process descriptions or blocks in flow charts should be understood as representing modules, segments, or portions of code which include one or more executable instructions for implementing specific logical functions or steps in the process. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of controlling or interacting with a deformed touch-sensitive display as described herein. The non-processor circuits may include, but are not limited to, a radio receiver, a radio transmitter, signal drivers, clock circuits, power source circuits, and user input devices. As such, these functions may be interpreted as steps of a method to perform control or actuation of the deformed touch sensitive display. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially” and “about” are used to refer to dimensions, orientations, or alignments inclusive of manufacturing tolerances. Thus, a “substantially orthogonal” angle with a manufacturing tolerance of plus or minus two degrees would include all angles between 88 and 92, inclusive. Also, reference designators shown herein in parenthesis indicate components shown in a figure other than the one in discussion. For example, talking about a device (10) while discussing figure A would refer to an element, 10, shown in figure other than figure A.

As noted above, in many modern electronic devices, touch-sensitive displays are included instead of physical keyboards. These touch-sensitive displays serve as the primary user interface for the electronic device. Embodiments of the disclosure contemplate that when a user is manipulating such a touch-sensitive display, one or more of the user's finger or the user's hand can obscure the display during the interaction. This obstruction of content or user actuation targets can negatively affect the user experience. Moreover, the visual obstruction can potentially make it difficult to perform an operation. Illustrating by example, when a user is editing text, the fact that their finger covers a word being edited makes it difficult to make accurate changes.

Embodiments of the disclosure advantageously work to solve this problem by providing an electronic device with a flexible display that can be physically deformed by one or more bends or folds. A deformable housing supports the flexible display. Using the flexible display, embodiments of the disclosure advantageously leverage the touch-sensitivity of the flexible display to allow control of a first portion of the flexible display, e.g., the portion to the right of a bend or deformation location, by interacting with a second portion of the flexible display, e.g., the portion to the left of a bend or deformation location. Embodiments of the disclosure advantageously map touch input on one side of the deformed device to control the other, thereby providing an intuitive user-interface that is easily controlled, and that obviates the “finger obstruction” problem described above.

In one or more embodiments, a flexible display includes a touch sensor that maps user input along a first portion of the flexible display disposed to a first side of the deformation location to control a second portion of the flexible display disposed to a second side of the deformation location. In one or more embodiments, touch input at the first portion of the flexible display provides control features, such as tracking, single taps, double taps, swipes, and so forth, along the second portion of the flexible display. Tracking of finger locations along the first portion can be rendered along the second portion so that they are easily seen, such as by a ring, color shift, cursor, or other visual indicia. A user can actuate a user actuation target by tapping a location on the first portion of the flexible display that is mapped to a corresponding location on the second portion of the flexible display.

In one or more embodiments, the housing of the electronic device is deformable. Internal and external components can be flexible as well. For instance, flexible batteries and flexible circuit boards can support various components within the electronic device. Touch sensors and substrates can be flexible as well. Remaining or other components disposed within the electronic device, such as one or more processors, other sensors, and other devices, are arranged such that a user can flex, bend, and/or fold the electronic device by executing a bending operation that physically deforms one or more of the housing or display into a deformed geometry.

In other embodiments, the housing may include rigid components that are linked together by one or more hinges. Such hinges can provide a solution offering needed system flexibility by providing support and movement for the flexible display during bending or folding operations. A multi-link hinge with support beams disposed beneath the flexible display, for example, can support the flexible display while allowing portions of the housing to pivot about an axis of the hinge.

In one or more embodiments, when the flexible display is deformed by one or more bends at a deformation portion, one or more processors operable with the flexible display are configured to divide the flexible display into a first portion disposed to one side of the bend and a second portion disposed to a second side of the bend. In one or more embodiments, the one or more processors then present content on one of the first portion or the second portion, detect user input along another of the first portion or the second portion, and control the content in response to the user input.

For instance, when the electronic device is folded in half with one side facing the user, i.e., the “front side,” and another side facing away from the user, i.e, the rear side, touch input along the rear side provides a tracking state indicating where the user's finger is along the rear side on the front side via a ring, cursor, or color shift. Actuation of user actuation targets presented on the front side can be accomplished, in one embodiment, by releasing and tapping the same spot on the rear side. In one or more embodiments, rear-side touch of the deformed, flexible display can be calibrated in accordance with user preferences. This calibration can be refined during actual use to make control and actuation more accurate and efficient.

Rear-side touch and front-side control can further, in one or more embodiments, be activated and/or deactivated based on how the electronic device is used. Illustrating by example, in one or more embodiments an image capture device can detect the presence of a user to one side of the electronic device. The one or more processors, in response to this detection, can then present content, information, and user actuation targets along the side facing the user, while using the other side only for control and omitting the presentation of content, information, and user actuation targets on the rear side. In another embodiment, rear-side touch and front-side content display are activated and/or deactivated when the user selects which side will be designated as the “front side” by a user interface interaction such as swiping the active “presentation” display side to the opposite side as desired.

The deformability of embodiments of the disclosure not only offer unique ways of controlling content with rear-side touch and front-side presentation, but can additionally make the device easier to use. For example, by being able to stand an otherwise thin electronic device on its side, the display can be easily viewable despite the fact that the electronic device is out of the user's hand. Bending the device into folded and multifold shapes allows the device to transform into a “self-standing” device, which can free a user's hands for other activities.

In one or more embodiments, the electronic device can be bent or deformed into different deformed geometries. Illustrating by example, if the electronic device is bent with a single fold, when placed on a table the electronic device can resemble a card folded into a “tent fold.” Where this occurs, one or more processors of the electronic device can partition the display into two parts, with each part being on a different side of the “tent,” using one for user input receipt and the other for the presentation of content, information, and user actuation targets. In other embodiments, a number of bends can be used to partition the display. Where this is the case, the one or more processors may be able to present four images in a predefined aspect ratio to provide rear-side user input reception and front-side content presentation capabilities to two different users. More permutations are completely possible. Still others will be obvious to those of ordinary skill in the art having the benefit of this disclosure.

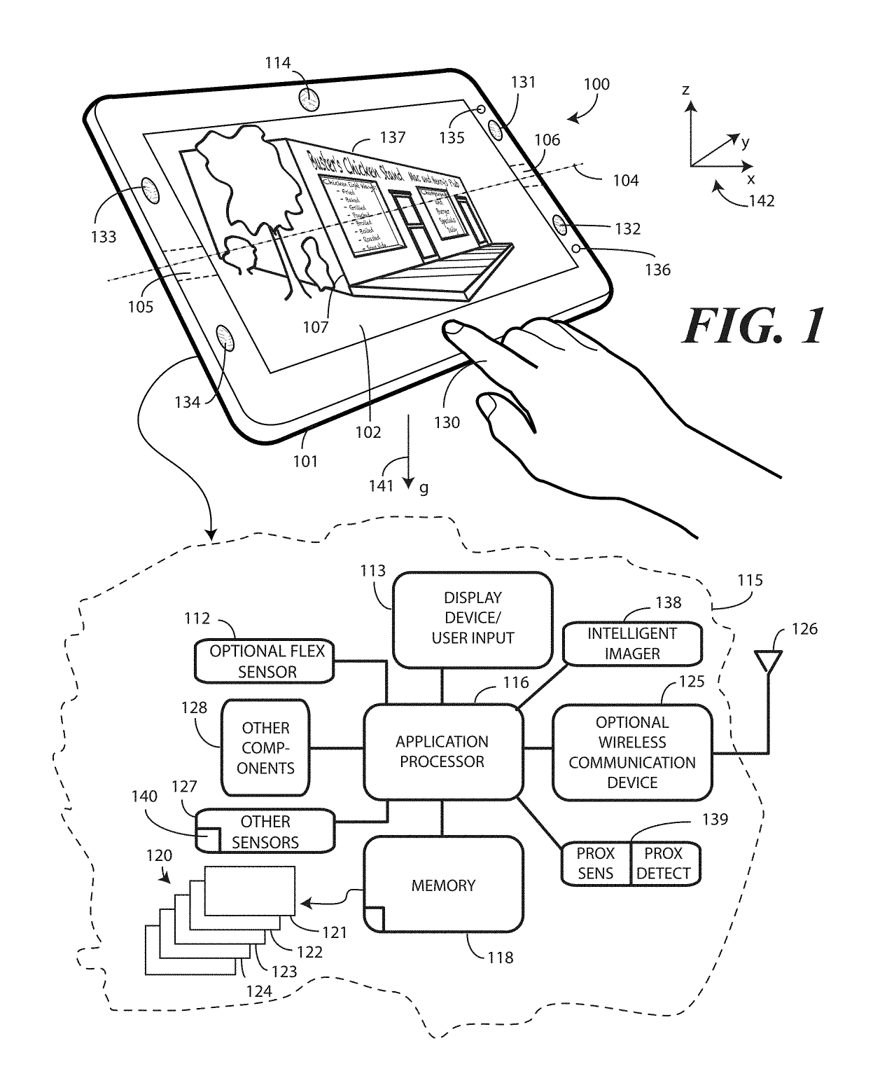

Turning now to FIG. 1, illustrated therein is one explanatory electronic device 100 configured in accordance with one or more embodiments of the disclosure. The electronic device 100 of FIG. 1 is a portable electronic device, and is shown operating as a tablet computer. This illustrative electronic device 100 includes a display 102, which is touch-sensitive. The display 102 can serve as a primary user interface of the electronic device 100. Users can deliver user input to the display 102 of such an embodiment by delivering touch input from a finger, stylus, or other objects disposed proximately with the display.

In one embodiment, the display 102 is configured as an organic light emitting diode (OLED) display fabricated on a flexible plastic substrate. However, it should be noted that other types of displays would be obvious to those of ordinary skill in the art having the benefit of this disclosure. In one or more embodiments, an OLED is constructed on flexible plastic substrates can allow the display 102 to become flexible in one or more embodiments with various bending radii. For example, some embodiments allow bending radii of between thirty and six hundred millimeters to provide a bendable display. Other substrates allow bending radii of around five millimeters to provide a display that is foldable through active bending. Other displays can be configured to accommodate both bends and folds. In one or more embodiments the display 102 may be formed from multiple layers of flexible material such as flexible sheets of polymer or other materials.

The explanatory electronic device 100 of FIG. 1 also includes a housing 101 supporting the display 102. In one or more embodiments, the housing 101 is flexible. In one embodiment, the housing 101 may be manufactured from a malleable, bendable, or physically deformable material such as a flexible thermoplastic, flexible composite material, flexible fiber material, flexible metal, organic or inorganic textile or polymer material, or other materials. In other embodiments, the housing 101 could also be a combination of rigid segments connected by hinges 105,106 or flexible materials. Still other constructs will be obvious to those of ordinary skill in the art having the benefit of this disclosure.

Where the housing 101 is a deformable housing, it can be manufactured from a single flexible housing member or from multiple flexible housing members. In this illustrative embodiment, a user interface component 114, which may be a button or touch sensitive surface, can also be disposed along the housing 101 to facilitate control of the electronic device 100. Other features can be added, and can be located on the front of the housing 101, sides of the housing 101, or the rear of the housing 101. Illustrating by example, in one or more embodiments a first image capture device 135 can be disposed on one side of the electronic device 100, while a second image capture device 136 is disposed on another side of the electronic device 100.

A block diagram schematic 115 of the electronic device 100 is also shown in FIG. 1. In one embodiment, the electronic device 100 includes one or more processors 116. The one or more processors 116 can be a microprocessor, a group of processing components, one or more Application Specific Integrated Circuits (ASICs), programmable logic, or other type of processing device. The one or more processors 116 can be operable with the various components of the electronic device 100. The one or more processors 116 can be configured to process and execute executable software code to perform the various functions of the electronic device 100. A storage device, such as memory 118, can optionally store the executable software code used by the one or more processors 116 during operation.

In one or more embodiments when the electronic device 100 is deformed by a bend at a deflection portion, the one or more processors 116 divide the display 102 into a first portion disposed to one side of the bend and a second portion disposed to a second side of the bend. As will be described in more detail below, in one or more embodiments the one or more processors 116 then present content on one of the first portion or the second portion, while detecting user input along another of the first portion or the second portion. For example, the one or more processors 116 can present content on a portion to the left of the bend, while receiving user input on a portion to the right of the bend. In one or more embodiments, the one or more processors 116 then control the content in response to the user input. Accordingly, the user can touch the display 102 to one side of the bend and control content presented on another side of the bend.

In one or more embodiments, the one or more processors 116 are further responsible for performing the primary functions of the electronic device 100. For example, in one embodiment the one or more processors 116 comprise one or more circuits operable to present presentation information, such as images, text, and video, on the display 102. The executable software code used by the one or more processors 116 can be configured as one or more modules 120 that are operable with the one or more processors 116. Such modules 120 can store instructions, control algorithms, and so forth.

In one embodiment, the one or more processors 116 are responsible for running the operating system environment 121. The operating system environment 121 can include a kernel, one or more drivers 122, and an application service layer 123, and an application layer 124. The operating system environment 121 can be configured as executable code operating on one or more processors or control circuits of the electronic device 100.

In one or more embodiments, the one or more processors 116 are responsible for managing the applications of the electronic device 100. In one or more embodiments, the one or more processors 116 are also responsible for launching, monitoring and killing the various applications and the various application service modules. The applications of the application layer 124 can be configured as clients of the application service layer 123 to communicate with services through application program interfaces (APIs), messages, events, or other inter-process communication interfaces.

In this illustrative embodiment, the electronic device 100 also includes a communication circuit 125 that can be configured for wired or wireless communication with one or more other devices or networks. The networks can include a wide area network, a local area network, and/or personal area network. Examples of wide area networks include GSM, CDMA, W-CDMA, CDMA-2000, iDEN, TDMA, 2.5 Generation 3GPP GSM networks, 3rd Generation 3GPP WCDMA networks, 3GPP Long Term Evolution (LTE) networks, and 3GPP2 CDMA communication networks, UMTS networks, E-UTRA networks, GPRS networks, iDEN networks, and other networks.

The communication circuit 125 may also utilize wireless technology for communication, such as, but are not limited to, peer-to-peer or ad hoc communications such as HomeRF, Bluetooth and IEEE 802.11 (a, b, g or n), and other forms of wireless communication such as infrared technology. The communication circuit 125 can include wireless communication circuitry, one of a receiver, a transmitter, or transceiver, and one or more antennas 126.

As shown in FIG. 1, the one or more processors 116 are presenting content 107 on the display 102. The content 107 of this illustration is a graphical image. In one or more embodiments, content 107 is retrieved, using the communication circuit 125, from one or more remote servers. The content 107 can be retrieved locally as well. The content 107 can include one or more user actuation targets 137, which a user 130 can touch to execute operations such as launching an application, opening a web page, navigating to a different screen, and so forth.

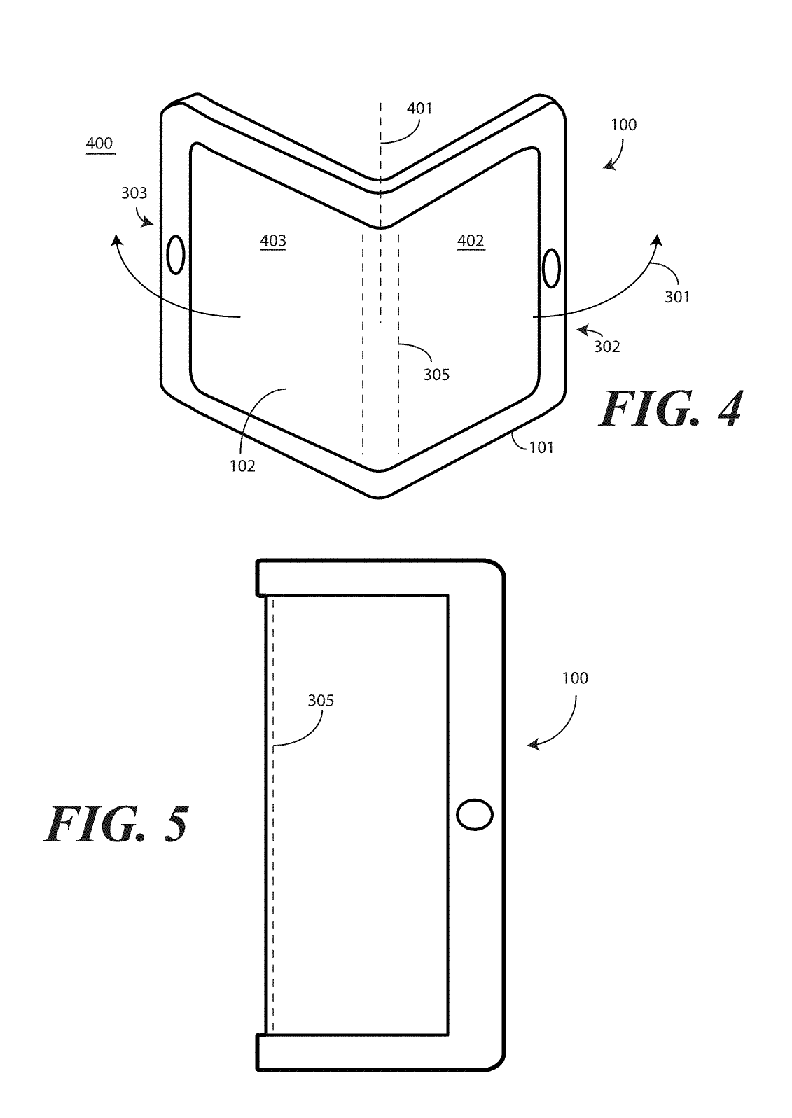

In one embodiment, the electronic device 100 includes one or more flex sensors 112, supported by the housing 101 and operable with the one or more processors 116, to detect a bending operation deforming one or more of the housing 101 or the display 102 into a deformed geometry, such as that shown in FIGS. 4-6. The inclusion of flex sensors 112 is optional, and in some embodiment flex sensors 112 will not be included. As one or more functions of the electronic device 100 occur when the display 102 is deformed by one or more bends, where flex sensors 112 are not included, the user can alert the one or more processors 116 to the fact that the one or more bends are present through the user interface 113 or by other techniques.

In one embodiment, the flex sensors 112 each comprise passive resistive devices manufactured from a material with an impedance that changes when the material is bent, deformed, or flexed. By detecting changes in the impedance as a function of resistance, the one or more processors 116 can use the one or more flex sensors 112 to detect bending or flexing. In one or more embodiments, each flex sensor 112 comprises a bi-directional flex sensor that can detect flexing or bending in two directions. In one embodiment, the one or more flex sensors 112 have an impedance that increases in an amount that is proportional with the amount it is deformed or bent.

In one embodiment, each flex sensor 112 is manufactured from a series of layers combined together in a stacked structure. In one embodiment, at least one layer is conductive, and is manufactured from a metal foil such as copper. A resistive material provides another layer. These layers can be adhesively coupled together in one or more embodiments. The resistive material can be manufactured from a variety of partially conductive materials, including paper-based materials, plastic-based materials, metallic materials, and textile-based materials. In one embodiment, a thermoplastic such as polyethylene can be impregnated with carbon or metal so as to be partially conductive, while at the same time being flexible.

In one embodiment, the resistive layer is sandwiched between two conductive layers. Electrical current flows into one conductive layer, through the resistive layer, and out of the other conductive layer. As the flex sensor 112 bends, the impedance of the resistive layer changes, thereby altering the flow of current for a given voltage. The one or more processors 116 can detect this change to determine an amount of bending. Taps can be added along each flex sensor 112 to determine other information, including the number of folds, the degree of each fold, the location of the folds, the direction of the folds, and so forth. The flex sensor 112 can further be driven by time-varying signals to increase the amount of information obtained from the flex sensor 112 as well.

While a multi-layered device as a flex sensor 112 is one configuration suitable for detecting a bending operation occurring to deform the electronic device 100 and a geometry of the electronic device 100 after the bending operation, others can be used as well. For example, in another embodiment the proximity sensors can be used to detect how far a first end of the electronic device 100 is from a second end of the electronic device 100. In yet another embodiment, Hall effect sensors can be used to sense open and/or closed state of the electronic device 100 as well. Still other types of flex sensors 112 will be obvious to those of ordinary skill in the art having the benefit of this disclosure.

In one or more embodiments, each of the first image capture device 135 and the second image capture device 136 comprises an intelligent imager 138. An intelligent imager 138 can capture one or more images of environments about the electronic device 100 and determine whether the object matches predetermined criteria. For example, the intelligent imager 138 operate as an identification module configured with optical recognition such as include image recognition, character recognition, visual recognition, facial recognition, color recognition, shape recognition and the like. Advantageously, the intelligent imager 138 can recognize whether a user's face or eyes are disposed to a first side of the electronic device 100 when it is folded or to a second side. Similarly, the intelligent imager 138, in one embodiment, can detect whether the user 130 is gazing toward a portion of the display 102 disposed to a first side of a bend or another portion of the display 102 disposed to a second side of a bend. In yet another embodiment, the intelligent imager 138 can determine where a user's eyes or face are located in three-dimensional space relative to the electronic device 100.

In addition to, or instead of the intelligent imager 138, one or more proximity sensors 139 can determine to which side of the electronic device 100 the user 130 is positioned when the electronic device 100 is deformed. The proximity sensors 139 can include one or more proximity sensor components. The proximity sensors 139 can also include one or more proximity detector components. In one embodiment, the proximity sensor components comprise only signal receivers. By contrast, the proximity detector components include a signal receiver and a corresponding signal transmitter.

While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers. The infrared transmitters are configured, in one embodiment, to transmit infrared signals having wavelengths of about 860 nanometers, which is one to two orders of magnitude shorter than the wavelengths received by the proximity sensor components. The proximity detector components can have signal receivers that receive similar wavelengths, i.e., about 860 nanometers.

In one or more embodiments the proximity sensor components have a longer detection range than do the proximity detector components due to the fact that the proximity sensor components detect heat directly emanating from a person's body (as opposed to reflecting off the person's body) while the proximity detector components rely upon reflections of infrared light emitted from the signal transmitter. For example, the proximity sensor component may be able to detect a person's body heat from a distance of about ten feet, while the signal receiver of the proximity detector component may only be able to detect reflected signals from the transmitter at a distance of about one to two feet.

In one embodiment, the proximity sensor components comprise an infrared signal receiver so as to be able to detect infrared emissions from a person. Accordingly, the proximity sensor components require no transmitter since objects disposed external to the housing 101 of the electronic device 100 deliver emissions that are received by the infrared receiver. As no transmitter is required, each proximity sensor component can operate at a very low power level. Evaluations show that a group of infrared signal receivers can operate with a total current drain of just a few microamps (˜10 microamps per sensor). By contrast, a proximity detector component, which includes a signal transmitter, may draw hundreds of microamps to a few milliamps.

In one embodiment, one or more proximity detector components can each include a signal receiver and a corresponding signal transmitter. The signal transmitter can transmit a beam of infrared light that reflects from a nearby object and is received by a corresponding signal receiver. The proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

In one embodiment, the one or more processors 116 may generate commands or execute control operations based on information received from the various sensors, including the one or more flex sensors 112, the user interface 113, or the other sensors 127. The one or more processors 116 may also generate commands or execute control operations based upon information received from a combination of the one or more flex sensors 112, the user interface 113, or the other sensors 127. Alternatively, the one or more processors 116 can generate commands or execute control operations based upon information received from the one or more flex sensors 112 or the user interface 113 alone. Moreover, the one or more processors 116 may process the received information alone or in combination with other data, such as the information stored in the memory 118.

The other sensors 127 may include a microphone, an earpiece speaker, a loudspeaker, key selection sensors, a touch pad sensor, a touch screen sensor, a capacitive touch sensor, and one or more switches. Touch sensors may used to indicate whether any of the user actuation targets present on the display 102 are being actuated. Alternatively, touch sensors disposed in the housing 101 can be used to determine whether the electronic device 100 is being touched at side edges or major faces of the electronic device 100 are being performed by a user 130. The touch sensors can include surface and/or housing capacitive sensors in one embodiment. The other sensors 127 can also include video sensors (such as a camera).

The other sensors 127 can also include motion detectors, such as one or more accelerometers or gyroscopes. For example, an accelerometer may be embedded in the electronic circuitry of the electronic device 100 to show vertical orientation, constant tilt and/or whether the electronic device 100 is stationary. The measurement of tilt relative to gravity is referred to as “static acceleration,” while the measurement of motion and/or vibration is referred to as “dynamic acceleration.” A gyroscope can be used in a similar fashion. In one embodiment the motion detectors are also operable to detect movement, and direction of movement, of the electronic device 100 by a user 130.

In one or more embodiments, the other sensors 127 include a gravity detector 140. For example, as one or more accelerometers and/or gyroscopes may be used to show vertical orientation, constant, or a measurement of tilt relative to gravity 141. Accordingly, in one or more embodiments, the one or more processors 116 can use the gravity detector 140 to determine an orientation of the electronic device 100 in three-dimensional space 142 relative to the direction of gravity 141. If, for example, the direction of gravity 141 flows from a first portion of the display 102 to a second portion of the display 102 when the electronic device 100 is folded, the one or more processors 116 can conclude that the first portion of the display 102 is facing upward. By contrast, if the direction of gravity 141 flows from the second portion to the first, the opposite would be true, i.e., the second portion of the display 102 would be facing upward.

Other components 128 operable with the one or more processors 116 can include output components such as video outputs, audio outputs, and/or mechanical outputs. Examples of output components include audio outputs, an earpiece speaker, haptic devices, or other alarms and/or buzzers and/or a mechanical output component such as vibrating or motion-based mechanisms. Still other components will be obvious to those of ordinary skill in the art having the benefit of this disclosure.

It is to be understood that FIG. 1 is provided for illustrative purposes only and for illustrating components of one electronic device 100 in accordance with embodiments of the disclosure, and is not intended to be a complete schematic diagram of the various components required for an electronic device. Therefore, other electronic devices in accordance with embodiments of the disclosure may include various other components not shown in FIG. 1, or may include a combination of two or more components or a division of a particular component into two or more separate components, and still be within the scope of the present disclosure.

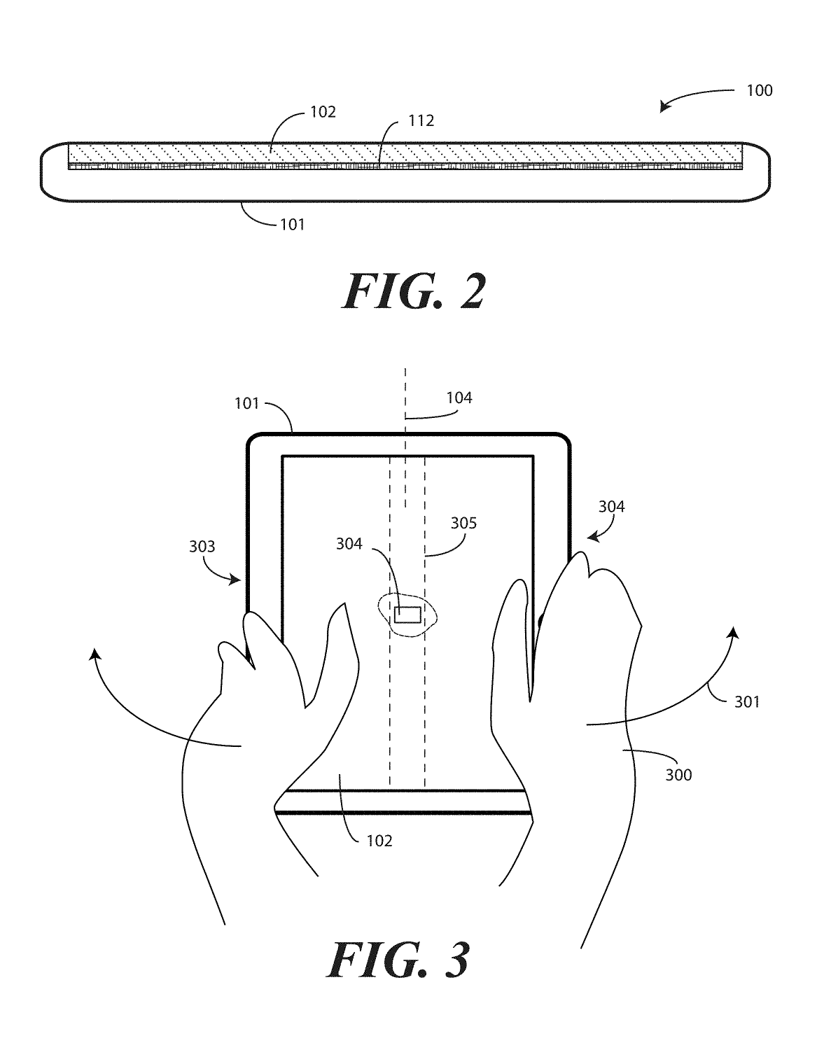

Now that the various hardware components have been described, attention will be turned to methods, systems, and use cases in accordance with one or more embodiments of the disclosure. Beginning with FIG. 2, illustrated therein is a sectional view of the electronic device 100. Shown with the electronic device 100 are the display 102 and the housing 101, each of which is flexible in this embodiment. Also shown is the flex sensor 112, which spans at least two axes (along the width of the page and into the page as viewed in FIG. 2) of the electronic device 100.

Turning now to FIG. 3, the user 130 is executing a bending operation 301 upon the electronic device 100 to impart deformation at a deformation portion 305 of the electronic device 100. In this illustration, the user 130 is applying force (into the page) at the first side 302 and a second side 303 of the electronic device 100 to bend both the housing 101, which is deformable in this embodiment, and the display 102 at the deformation portion 305. Internal components disposed along flexible substrates are allowed to bend as well along the deformation portion 305. This method of deforming the housing 101 and display 102 allows the user 130 to simply and quickly bend the electronic device 100 into a desired deformed physical configuration or shape.

In other embodiments, rather than relying upon the manual application of force, the electronic device can include a mechanical actuator 304, operable with the one or more processors (116), to deform the display 102 by one or more bends. For example, a motor or other mechanical actuator can be operable with structural components to bend the electronic device 100 to predetermined angles and physical configurations in one or more embodiments. The use of a mechanical actuator 304 allows a precise bend angle or predefined deformed physical configurations to be repeatedly achieved without the user 130 having to make adjustments. However, in other embodiments the mechanical actuator 304 will be omitted to reduce component cost.

Regardless of whether the bending operation 301 is a manual one or is instead one performed by a mechanical actuator 304, it results in the display 102 being deformed by one or more bends. One result 400 of the bending operation 301 is shown in FIG. 4. In this illustrative embodiment, the electronic device 100 is deformed by a single bend 401 at the deformation portion 305. However, in other embodiments, the one or more bends can comprise a plurality of bends. Other deformed configurations will be obvious to those of ordinary skill in the art having the benefit of this disclosure.

In one embodiment, the one or more processors (116) of the electronic device 100 are operable to detect that a bending operation 301 is occurring by detecting a change in an impedance of the one or more flex sensors (112). The one or more processors (116) can detect this bending operation 301 in other ways as well. For example, the touch sensors can detect touch and pressure from the user (130). Alternatively, the proximity sensors can detect the first side 402 and the second side 403 of the electronic device 100 getting closer together. Force sensors can detect an amount of force that the user (130) is applying to the housing 101 as well. The user (130) can input information indicating that the electronic device 100 has been bent using the display 102 or other user interface (113). Other techniques for detecting that the bending operation (301) has occurred will be obvious to those of ordinary skill in the art having the benefit of this disclosure.

Several advantages offered by the “bendability” of embodiments of the disclosure are illustrated in FIG. 4. For instance, in one or more embodiments the one or more processors (116) of the electronic device 100 are operable to, when the display 102 is deformed by one or more bends, present content, information, and/or user actuation targets on a first portion of the display 102 disposed to a first side of the bend 401, while receiving user input in the form of touch at a second portion of the display 102 disposed to a second side of the bend 401. This allows a user (130) to see content on the first portion, and control the content by delivering touch input to the second portion. Additionally, where the electronic device 100 is configured in the physical configuration shown in FIG. 4, which resembles a card folded into a “tent fold,” the electronic device 100 can stand on its side or ends on a flat surface such as a table. This configuration can make the display 102 easier for the user (130) to view since they do not have to hold the electronic device 100 in their hands.

In one or more embodiments, the one or more processors (116) are operable to detect the number of folds in the electronic device 100 resulting from the bending operation 301. In one embodiment, after determining the number of folds, the one or more processors (116) can partition the display 102 of the electronic device 100 as another function of the one or more folds. Since there is a single bend 401 here, in this embodiment the display 102 has been partitioned into a first portion and a second portion, with each portion being disposed on opposite sides of the “tent.”

In one or more embodiments, the bending operation 301 can continue from the physical configuration of FIG. 4 until the electronic device 100 is fully folded as shown in FIG. 5. Embodiments of the disclosure contemplate that a user (300) may hold the electronic device 100 in one hand when in this deformed physical configuration. For example, the user (130) may use the electronic device 100 as a smartphone in the folded configuration of FIG. 5, while using the electronic device 100 as a tablet computer in the unfolded configuration of FIG. 1 or FIG. 3. Accordingly, in one embodiment, the one or more processors (116) presents content only to one side of the deformation portion 305, in response to detecting the deformation. In this illustrative embodiment, the one side is to the right of the deformation portion 305. However, if the electronic device 100 were flipped over, as detected by the accelerometer, gyroscope, or other sensors (127), the one side would be to the left of the deformation portion 305.

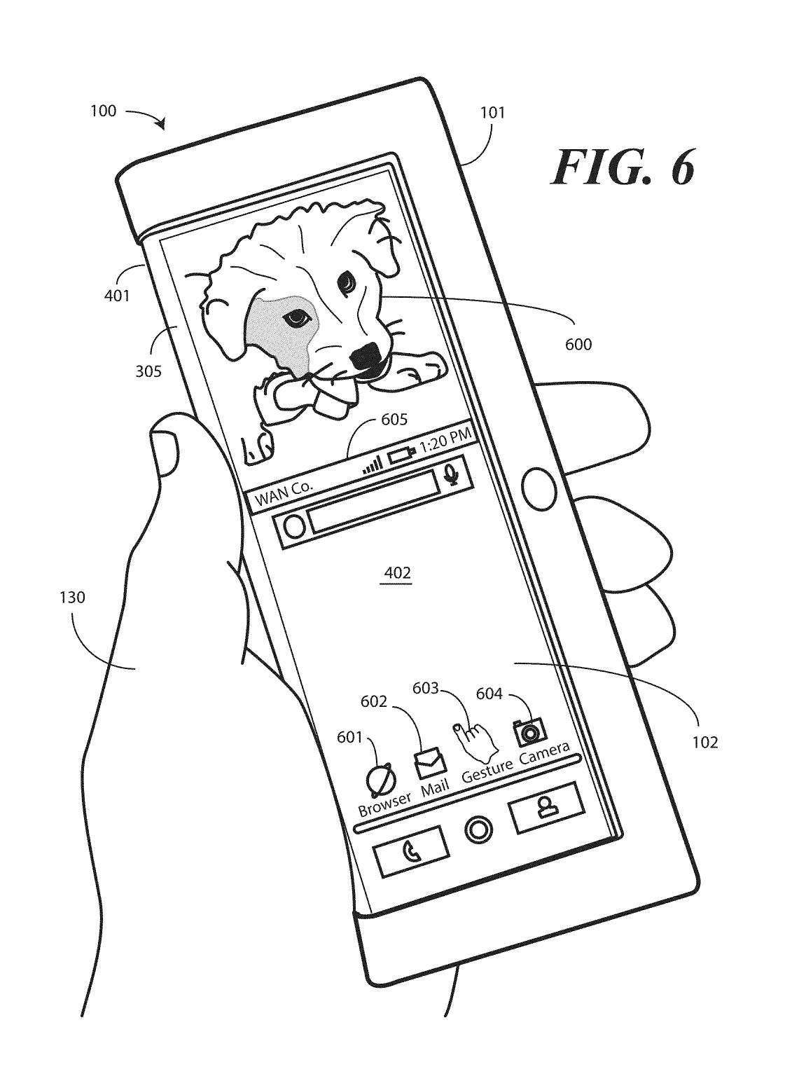

Turning now to FIG. 6, illustrated therein is the electronic device 100, in the folded configuration, being used by the user 130. The display 102 has been deformed by a bend 401 along a deformation portion 305. One or more flex sensors (112) have detected this deflection of the display 102. Optionally, the one or more flex sensors (112) additionally determine a location along the housing 101 defining the deformation portion 305, which allows the one or more processors (116) to adjust the presentation of the content 600 as a function of the bend 401.

In this illustration, one or more processors (116), operable with the one or more flex sensors (112), present content 600 on portions, e.g., portion 402, of the display 102 disposed to one side of the deflection defined by the bend 401. Here the content 600 comprises a smartphone home screen and a picture of the user's dog, Buster. Additionally, user actuation targets 601,602,603,604 and other content 605 are being presented on the display 102. Accordingly, the one or more processors (116) allows the user 300 to look at his dog, Buster, while using the electronic device 100 as a smartphone at the same time.

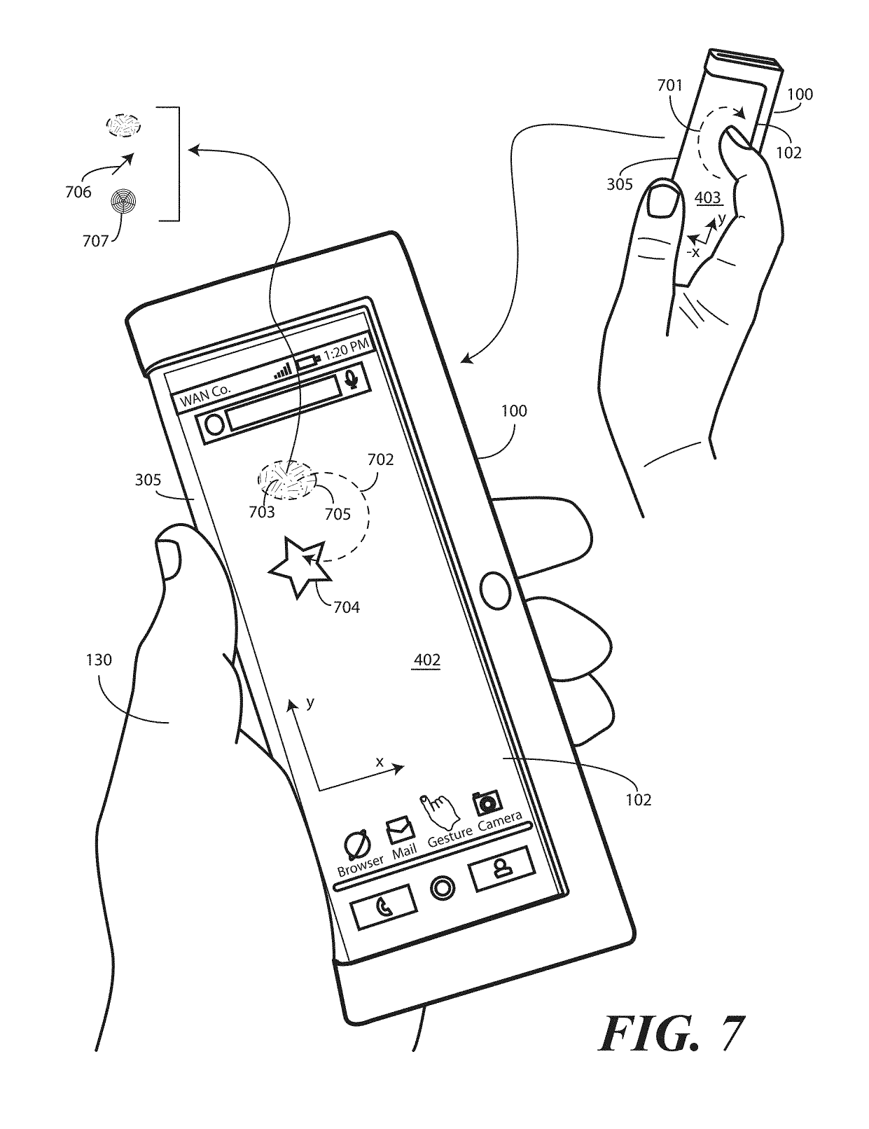

In one or more embodiments, the one or more processors (116) then detect user input along a second portion (403) of the display 102 disposed to a second side of the deformation portion 305, which is facing the user's palm in FIG. 6. The one or more processors (116) can then control the second portion (403) of the display 102. This is shown in FIG. 7.

Turning now to FIG. 7, the user 130 is delivering user input 701, in the form of touch input, to the second portion 403 of the display 102. Accordingly, the one or more processors (116) control 702 the first portion 402 of the display 102 as a function of the user input 701 received at the second portion 403 of the display 102. Here, the control 702 comprises navigating from an initial touch location 703 to a user actuation target 704.

In one or more embodiments, the one or more processors (116) map the vertical and horizontal dimensions of the second portion 403 of the display 102 to the first portion 402 of the display 102. In one embodiment, this comprises mapping X and Y coordinates of the second portion 403 of the display 102 to a mirror image of those coordinates along the first portion 402 of the display 102. Accordingly, the x-y coordinates on the first portion 402 of the display are aligned to the x-y coordinates on the second portion 403 of the display by determining the geometric position of the two portions relative to the deformation portion 305. Spatial calibration or other techniques could also be used. Thus, when the user 130 moves a finger along the second portion 403 of the display 102, control 702 of content, e.g., navigation to user actuation target 704, occurs on the first portion 402 of the display 102.

In this illustrative embodiment, the one or more processors (116) also present visible indicia 705 corresponding to the touch input along the first portion 402 of the display 102. In this illustrative embodiment, the visible indicia 705 comprise a halo. However, the visible indicia 705 could also comprise a cursor 706 or visible marker 707 identifying where the user's finger is touching the second portion 403 of the display 102. Still other visible indicia will be obvious to those of ordinary skill in the art having the benefit of this disclosure.

As shown in FIG. 7, the one or more processors (116) present content only to one side of the deformation portion 305, which is along the first portion 402 of the display 102 in this embodiment, in response to the one or more flex sensors (112) detecting deformation of the electronic device 100. In this illustrative embodiment, content presentation along the second portion 403 of the display 102 is omitted. This not only saves power, but reduces the loading upon the one or more processors (116). Additionally, it makes sense because the second portion 403 of the display 102 is directed away from the user's eyes. However, while omitting the presentation of content along the second side 403 of the display 102, the touch sensor operable with the second portion 403 of the display 102 remains active to receive user input 701.

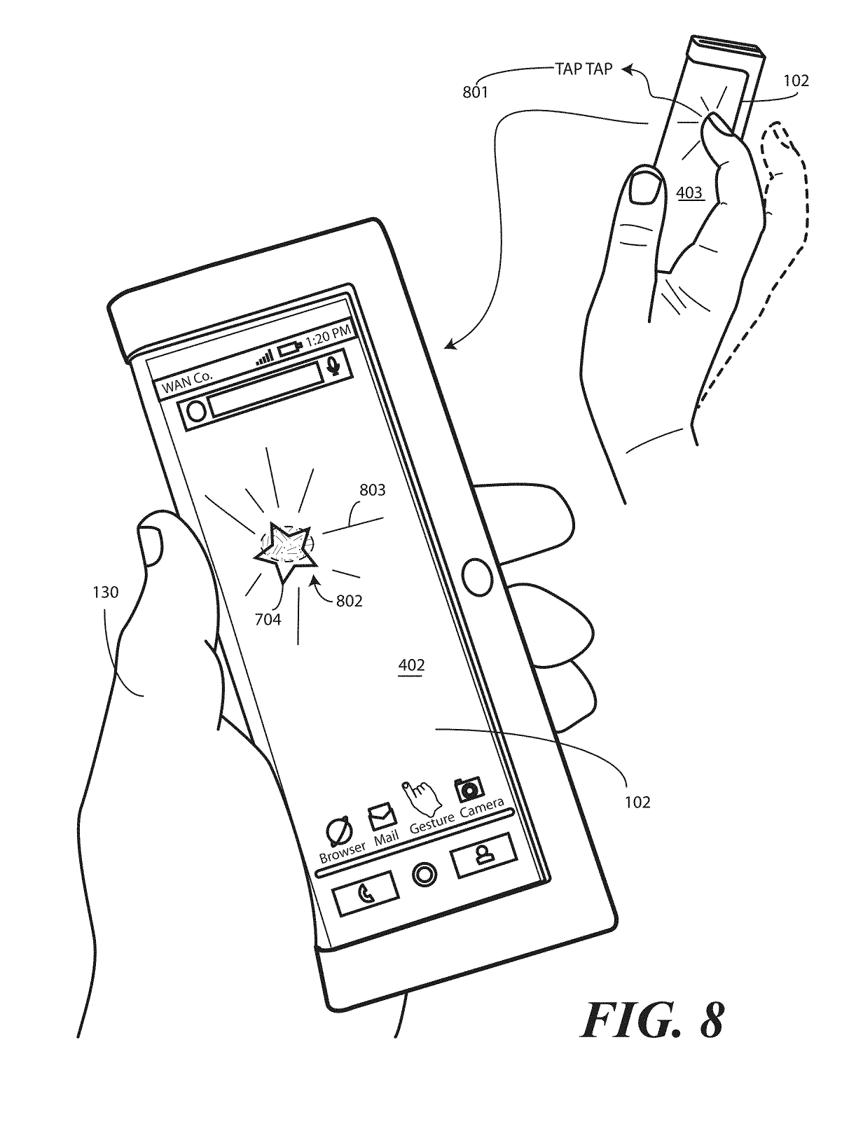

In one or more embodiments, the user 130 can further control the content presented upon the first portion 402 of the display 102 by delivering user input 701 to the second portion 403 of the display 102. Turning now to FIG. 8, one example of such control is illustrated.

As shown in FIG. 8, the user input 801 comprises a double-tap at a location 802 corresponding to the user actuation target 704. Accordingly, the one or more processors (116) can actuate 803 the user actuation target 704 in response to the double-tap. While a double-tap is one example of user input 801 from which the one or more processors (116) can actutae 803 the user actuation target 704, other user input can be used as well. For example, the user input 801 could comprise a single-tap, pinch, pull, swipe, drag, press, or other user input. Still other forms of user input will be obvious to those of ordinary skill in the art having the benefit of this disclosure. Advantageously, by delivering the double-tap to the second portion 403 of the display 102, the user 130 is able to actuate 803 the user actuation target 704 in an unobstructed manner. This is true because the user 130 is not required to place a finger, stylus, or other object atop the user actuation target 704 to impart control.

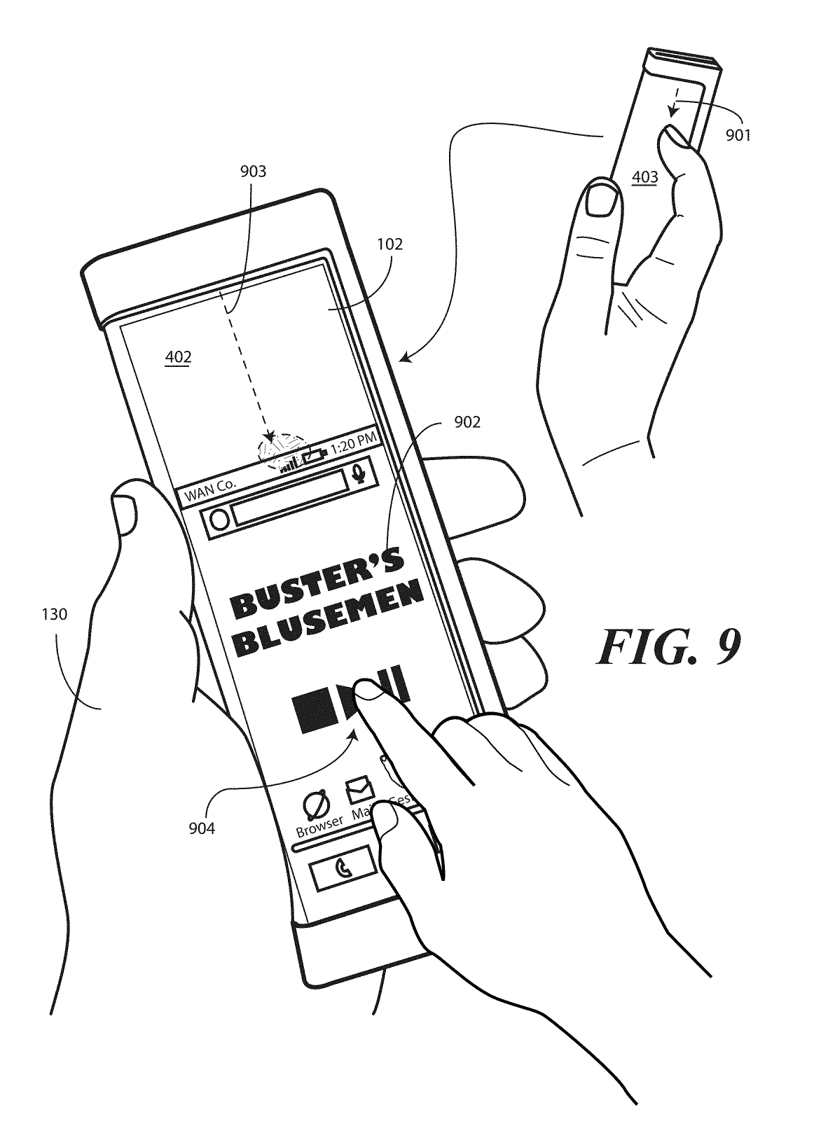

Turning now to FIG. 9, illustrated therein is another form of user input 901 applied to a second portion 403 of the display 102 to control content 902 being presented on a first portion 402 of the display 102. In this illustrative embodiment, the user input 901 comprises a swipe that causes the content 902 to translate 903 along the first portion 402 of the display 102. For instance, the user 130 may want to reduce the size of the content 902 so that other content, such as the picture of Buster, can be presented on repurposed portions of the first portion 402 of the display.

In this illustrative embodiment, the user 130 is also delivering other user input 904 to the first portion 402 of the display 102. Here, the content 902 comprises a music player application and the user 130 is delivering the other user input 904 to play a song. Thus, as shown, the one or more processors (116) detect the other user input 904 along the first portion 402 of the display 102 and control the content 902, e.g., play a song, in response to the other user input 904.

While the application and reason for delivering the other user input 904 will vary, this example makes it clear that the one or more processors (116) can detect, in one or more embodiments, user input 901 along the second portion 403 of the display 102 and other user input 904 along the first portion 402 of the display 102 to control content 902. Other applications where this “dual” user input may be useful would be to provide multi-touch capabilities that enable “gestures” such as pinching content 902 or pulling content 902 to create actions such as moving an icon, locking the screen, and so forth. Still other applications and gestures will be obvious to those of ordinary skill in the art having the benefit of this disclosure.

Illustrating by example, in one or more embodiments the user input 901 and the other user input 904 can be used together to make complex gestures. For example, the user input 901 may occur in a first direction, while the other user input 904 may occur in an opposite direction, with the user's fingers moving apart, thereby creating a combined “pull” gesture action to, for instance, magnify the content 902, scale the content 902, or otherwise manipulate the content 902. Similarly, the user input 901 may occur in a first direction, while the other user input 904 may occur in an opposite direction, with the user's fingers moving together, thereby creating a combined “pinch” gesture action to, for instance, reduce the content 902, descale the content 902, or otherwise manipulate the content 902.

Moreover, in other embodiments the user input 901 and the other user input 904 can be used in tandem to allow multi-touch control of the content 902. For instance, the user 130 might generate new actuation mechanisms through gesture controls to perform various electronic device operations, such as moving content 902, manipulating the content 902, locking or unlocking the electronic device 100, scrolling through content 902, or perform other operations. Thus, in one or more embodiments the combined user input 901 and other user input 902 are combined to define a multi-touch gesture to control the electronic device 100. These examples are illustrative only, as numerous others will be obvious to those of ordinary skill in the art having the benefit of this disclosure.

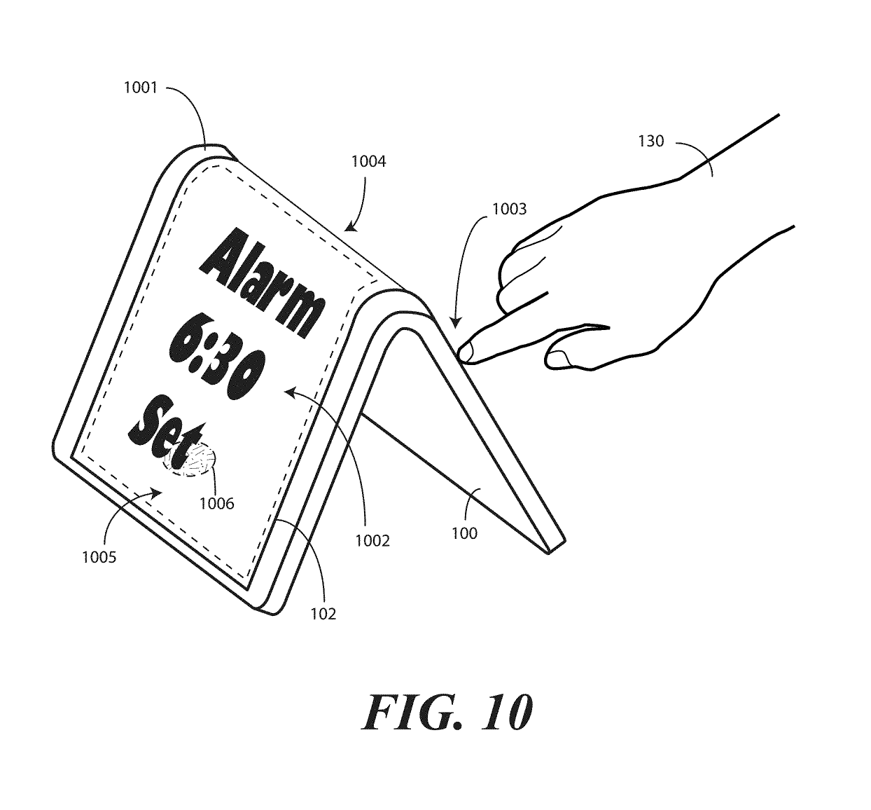

In FIG. 10, the electronic device 100 is partially formed to define a tent fold 1001. In one or more embodiments, the one or more processors (116) automatically select an operating mode as a function of the fold. For example, in this illustrative embodiment the tent fold 1001 launches an alarm clock mode of operation 1002. It should be understood that this launched mode of operation may be a default, and may be defined and/or overridden by the user 130 as desired. In another embodiment, the user 130 may want a picture show mode of operation to launch when the electronic device 100 is deformed to a tent fold 1001. Other modes that correspond to particular deformed states of the electronic device 100 will be obvious to those of ordinary skill in the art having the benefit of this disclosure.

As shown in FIG. 10, the user 130 is able to deliver user input 1003 to a rear portion 1004 of the display 102, which is disposed to the back side of the tent fold 1001. Visible indicia 1006, in the form of a visible marker, appears on a front portion 1005 of the display 102 disposed to the front side of the tent fold 1001. The user 130 is able to set an alarm by navigating the visible marker to the set button by passing a finger along the rear portion 1004 of the display 102, and then tapping or double tapping, depending upon how the electronic device 100 is configured, at the “set” user actuation target. Advantageously, this can be done without the user's finger obstructing the time, which is displayed on the front portion 1005 of the display. This leads to more accurate alarm setting and less oversleeping and missed appointments.

As noted above, in one or more embodiments, when the one or more processors (116) of the electronic device 100 detect deformation of the display 102 by a bend at a deformation location, e.g., the tent fold 1001 of FIG. 10, the one or more processors (116) then subdivide the display 102 into a first portion, e.g., front portion 1005, and a second portion, e.g., rear portion 1004. As shown in FIG. 10, the first portion is disposed to a first side of the deformation location and the second portion is disposed to a second side of the deformation location.

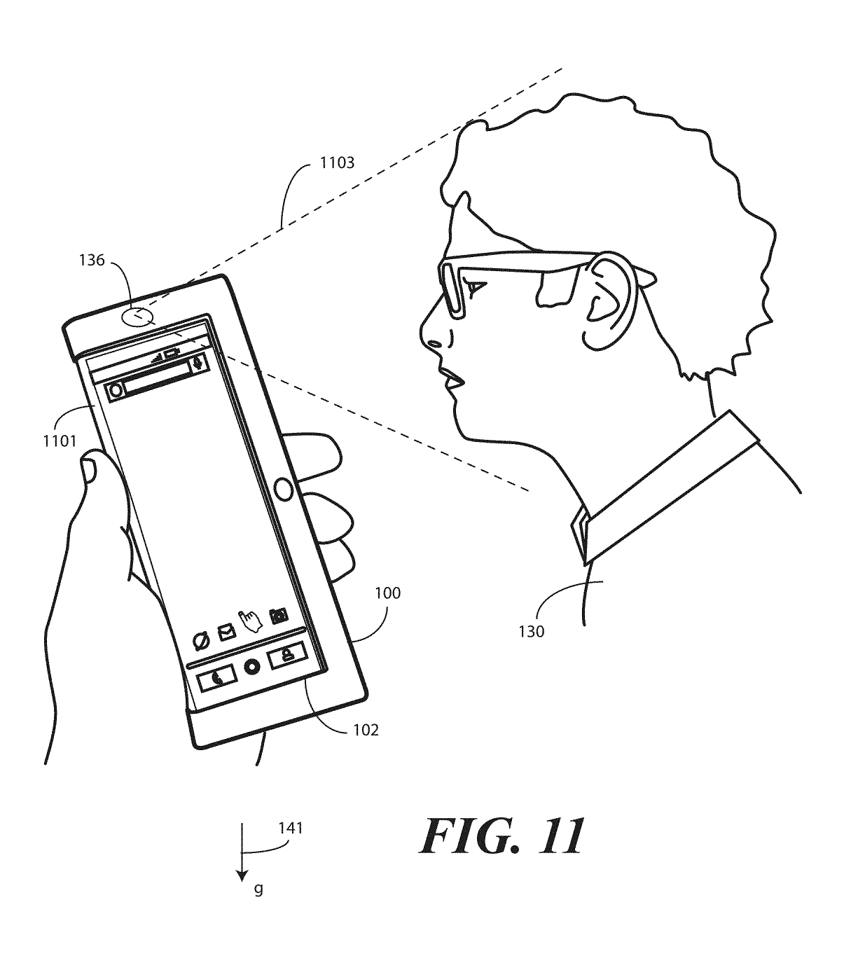

As also noted above, in one or more embodiments the one or more processors (116) present content, e.g., the alarm clock indicia shown in FIG. 10, only on one of the first side or the second side. Here, the one or more processors (116) present the alarm clock indicia on the front portion 1005. The rear portion 1004 does not include any content presentation, but is rather reserved for the reception of user input 1003. The decision regarding upon which of the first side or the second side of the deformation location content should be presented can be made in a variety of ways. Turning now to FIG. 11, illustrated therein is a first way this decision can be made. Specifically, FIG. 11 illustrates the use of one or more sensors (127) to detect an orientation of the electronic device 100 in three-dimensional space (142) relative to a user 130, so that the one or more processors (116) can determine whether to present the content on the first portion or the second portion of the display 102 as a function of the orientation of the electronic device 100 in three-dimensional space (142) relative to the user 130.

As shown in FIG. 11, the electronic device 100 includes at least one intelligent imager (138). In this illustrative embodiment, the electronic device 100 includes two intelligent imagers. Specifically, a first image capture device 136, operating as an intelligent imager (138), is disposed to one side of a deformable region 1101, while a second image capture device (135), also operating as an intelligent imager (138), is disposed to a second side of the deformable region 1101.

In one or more embodiments, the one or more processors (116) determine whether to present the content to the first side 1102 or to the second side (facing the user's palm) by capturing images 1103 of a user 130 to determine whether the first side 1102 or the second side is facing the user 130. For example, in one embodiment the one or more processors (116) or intelligent imager (138) can analyze the images 1103 captured by the first image capture device 136 to determine if the user's face or eyes are detected. If the user's face or eyes are detected, the one or more processors (116) present content on the first side 1102 of the display 102 disposed to a first side of the deformable region 1101 after detecting a bend. Similarly, if the one or more processors (116) or intelligent imager (138) detect the user's face or eyes in images captured by the second image capture device (135), content could be presented on the second side of the display 102 disposed to a second side of the deformable region 1101 after detecting a bend.

Alternatively, since an intelligent imager (138) may consume relatively high amounts of current, one or more proximity sensors (139) can be used in conjunction with the intelligent imager (138) to conserve power. Specifically, the one or more proximity sensors (139) can detect whether the user 130 is facing the first side 1102 or the second side, and can present content on that side. The intelligent imager can confirm this position of the user to avoid false positives. Since the user 130 is holding the electronic device 100 in the hand, the proximity sensors (139) on one side will saturate, while the proximity sensors (139) on the other side will detect the user's face. Accordingly, in one embodiment, the one or more processors (116) can present content on the side having unsaturated proximity sensors (139).

In still another embodiment, an accelerometer, gravity detector (140), or gyroscope can determine the orientation of the electronic device 100 in three-dimensional space (142). The one or more processors (116) can monitor the gravity detector (140) to detect, for example, a direction of gravity 141. Since the direction of gravity 141 flows from the first side 1102 to the second side in this example, the one or more processors (116) can present content on the first side 1102, concluding that it is facing upward and toward the user's face. The examples above are illustrative only, as numerous others will be obvious to those of ordinary skill in the art having the benefit of this disclosure.

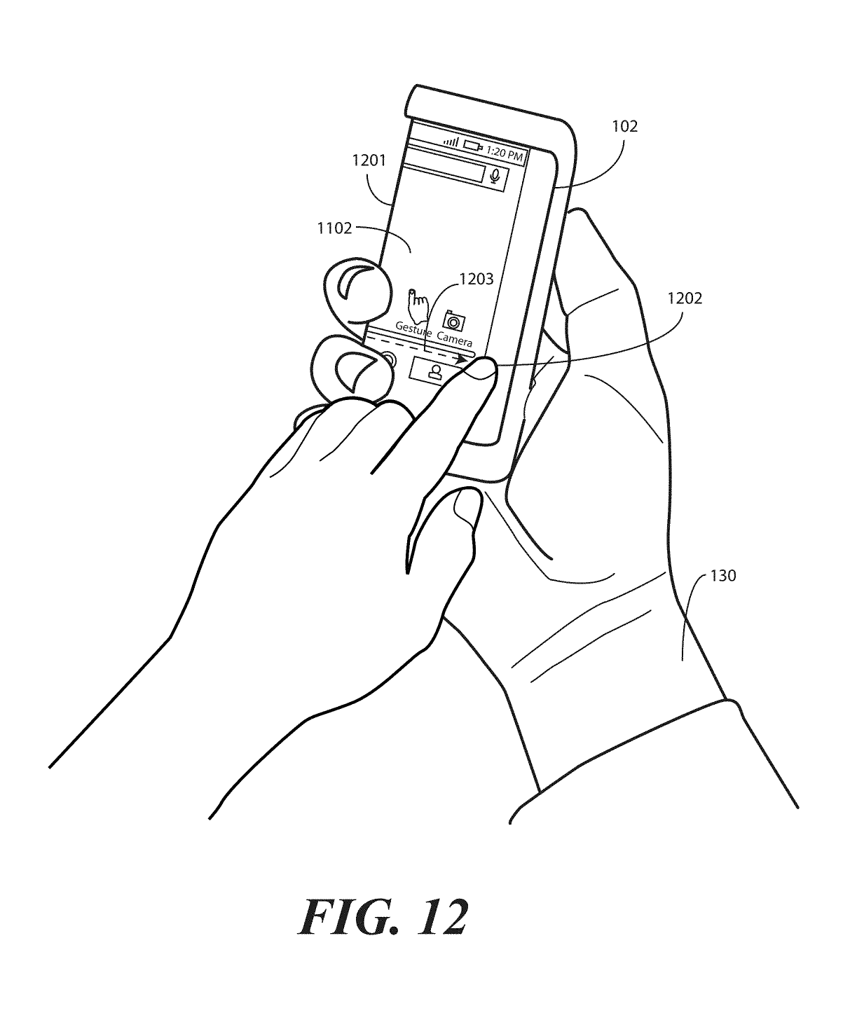

In other embodiments, the presentation of content can default to a predefined side of a deformation region defined by a bend. Since the default side may not be the side ultimately desired by the user, it can be changed in one or more embodiments. Turning now to FIG. 12, illustrated therein is one way in which this can occur.

In FIG. 12, when the one or more processors (116) detect a bend 1201, they by default present content on the second side of the bend 1201, i.e., the side facing the user's palm. However, as this side is not visible, the user 130 can manipulate the content to change sides.

In this illustrative embodiment, the one or more processors (116) detect user input 1202 beginning on the second side of the display 102 and sliding to the first side 1102 of the display. Accordingly, the one or more processors (116) cause the content to translate 1203 from the second side to the first side of the display 102. Essentially, using a swipe gesture, the user 130 can quickly and easily cause the content to translate 1203 from one side to the other as desired. Other techniques for moving content from one side of a bend 1201 to the other will be obvious to those of ordinary skill in the art having the benefit of this disclosure.

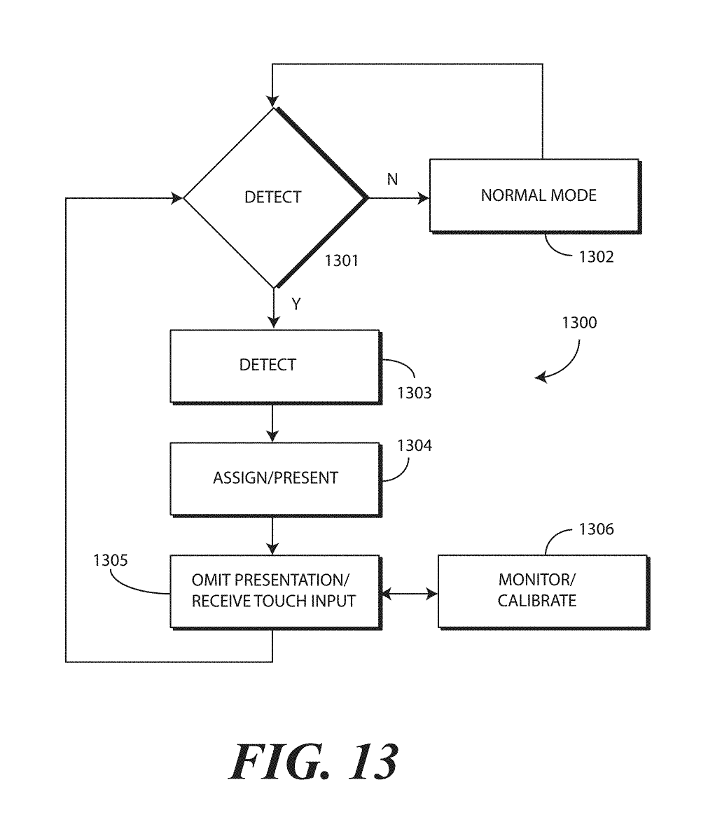

Turning now to FIG. 13, illustrated therein is one explanatory method 1300 for operating a deformable electronic device having a flexible display in accordance with one or more embodiments of the disclosure. Beginning at decision 1301, one or more processors of the electronic device determine whether the electronic device is deformed at a bend or deformation region. Where it is not, in one embodiment the one or more processors present content along the entire display, thereby operating in a normal mode of operation at step 1302.

Where the electronic device is deformed at a bend or deformation region, in one embodiment the method 1300 detects a user's presence to one side of the bend or deformation region at step 1303. As described above this step 1303 can be performed in any of a number of ways, including using an intelligent imager, proximity sensors, gravity detectors, or other techniques.

At step 1304, once the user's presence to one side of the bend or deformation region is detected, the method 1300 assigns the portion of the display disposed to that side of the bend or deformation region as the “front side” and presents content on the front side. At step 1305, the method 1300 omits the presentation of content on the other side, i.e., the “rear side,” and instead receives touch input. At step 1305, this touch input is mapped from the rear side to the front side as well. In one embodiment, this mapping comprises reflecting the touch input to the front side.

At step 1306, the method can include monitoring and calibration of the mapping. For example, a user may refold or re-bend or otherwise alter or change the location of the bend or deformation region. Step 1306 monitors such changes and adjusts the mapping of touch input from the rear side to control content on the front side.

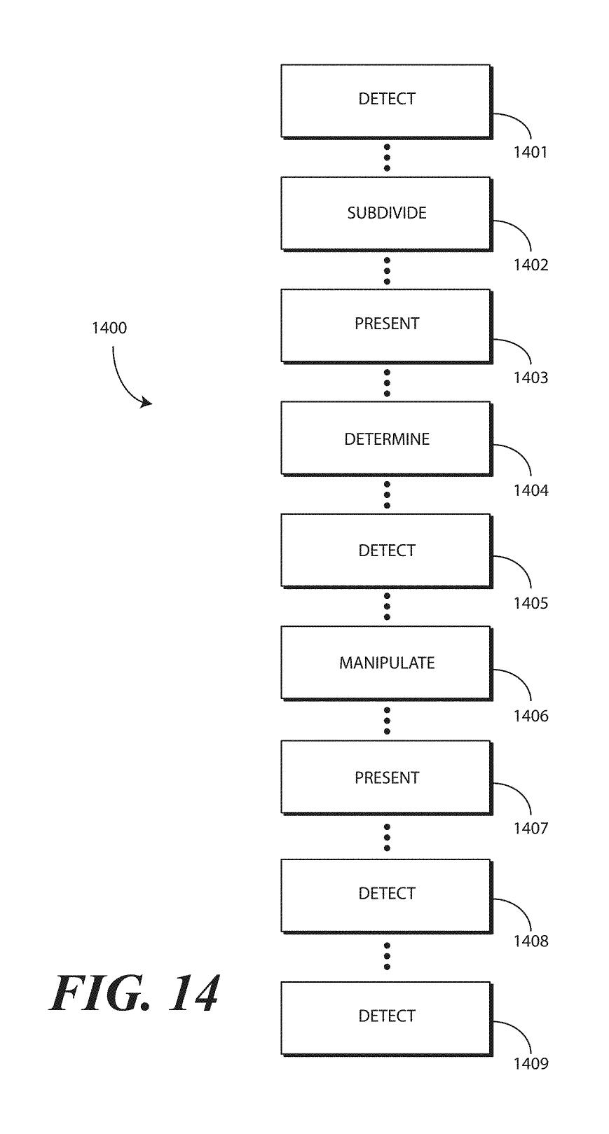

Turning now to FIG. 14, illustrated therein is another explanatory method 1400 for operating a deformable electronic device having a flexible display in accordance with one or more embodiments of the disclosure. At step 1401, the method 1400 detects, with one or more flex sensors, deformation of a flexible display by a bend at a deformation location. At step 1402, the method 1400 subdivides, with one or more processors operable with the flexible display, the flexible display into a first portion disposed to a first side of the deformation location and a second portion disposed to a second side of the deformation location. At step 1403, the method 1400 optionally presents content only on one of the first side or the second side.

At optional step 1404, the method 1400 determines whether to present the content on the first side or the second side by determining which of the first side or the second side faces a user. This can be done in a variety of ways, including by using an intelligent imager, proximity sensors, gravity detection, spatial orientation of the electronic device, or by other techniques.

At step 1405, the method 1400 detects, with a touch sensor operable with the flexible display, touch input on another of the first side or the second side. At step 1406, the method 1400 manipulates, with the one or more processors, the content as a function of the user input.

At optional step 1407, the method 1400 includes presenting indicia of the user input on the one of the first side or the second side. The presentation of this user input can be in the form of a halo, a cursor, a cross-hair, a spyglass, a magnifying glass, a visible indicator, or by other techniques.

At step 1408, the method 1400 optionally comprises detecting other touch input along another of the first side or the second side, and moving the content from the one of the first side or the second side to the another of the first side or the second side. This allows a user to change which side of the display is presenting content and which side is receiving touch input, as previously described.

At step 1409, the method 1400 comprises detecting, with the one or more flex sensors, removal of the bend. Embodiments of the disclosure contemplate that when a deformable electronic device is bent, the user will eventually want to “unbend” it to use it in a planar mode again. Accordingly, this unbending is detected at step 1409. Additionally, step 1409 can include again uniting the first side and the second side, and presenting content across the entirety of the display.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic device, comprising:
a deformable housing;
a flexible display supported by the deformable housing, the flexible display comprising a touch sensor;
one or more flex sensors detecting when the electronic device is deformed at a deformation location; and
one or more processors, operable with the flexible display and the one or more flex sensors, the one or more processors detecting user input along a first portion of the flexible display disposed to a first side of the deformation location, and controlling a second portion of the flexible display disposed to a second side of the deformation location as a function of the user input.

2. The electronic device of claim 1, the user input comprising touch input along the first portion of the flexible display.

3. The electronic device of claim 2, the one or more processors further presenting visible indicia corresponding to the touch input along the second portion of the flexible display.

4. The electronic device of claim 3, the visible indicia comprising one of a cursor, a halo, or a visible marker.

5. The electronic device of claim 1, the one or more processors presenting content only to one side of the deformation location in response to the one or more flex sensors detecting deformation of the electronic device.

6. The electronic device of claim 5, further comprising an intelligent imager, the one or more processors determining whether to present the content to the first side or to the second side by capturing images of a user.

7. The electronic device of claim 5, the one or more processors detecting other user input along the second portion of the flexible display and causing the content to translate from the second portion of the flexible display to the first portion of the flexible display.

8. The electronic device of claim 5, further comprising a gravity detector, the one or more processors determining whether to present the content to the first side or to the second side by detecting a gravitational direction.

9. The electronic device of claim 5, the content comprising one or more user actuation targets.

10. The electronic device of claim 9, the user input comprising one of a single tap or a double-tap at a user actuation target, the one or more processors actuating the user actuation target in response to the one of the single tap or the double-tap.

11. A method, comprising:
detecting, with one or more flex sensors, deformation of a flexible display by a bend at a deformation location;
subdividing, with one or more processors operable with the flexible display, the flexible display into a first portion disposed to a first side of the deformation location and a second portion disposed to a second side of the deformation location;
presenting content only on one of the first side or the second side;
detecting, with a touch sensor operable with the flexible display, touch input on another of the first side or the second side; and
manipulating, with the one or more processors, the content as a function of the user input.

12. The method of claim 11, further comprising presenting indicia of the user input on the one of the first side or the second side.

13. The method of claim 12, further comprising determining, with an intelligent imager, whether to present the content on the first side or the second side by determining which of the first side or the second side faces a user.

14. The method of claim 12, further comprising determining, with a gravity detector, whether to present the content on the first side or the second side by detecting a direction of gravity.

15. The method of claim 12, further comprising detecting other touch input along the another of the first side or the second side, and moving the content from the one of the first side or the second side to the another of the first side or the second side.

16. The method of claim 12, further comprising detecting, with the one or more flex sensors, removal of the bend, and again uniting the first side and the second side.

17. An electronic device, comprising:
a flexible display;
one or more flex sensors, the one or more flex sensors detecting deformation of the flexible display at a bend; and
one or more processors operable with the one or more flex sensors, the one or more processors dividing the flexible display into a first portion disposed to one side of the bend and a second portion disposed to a second side of the bend, presenting content on one of the first portion or the second portion, detecting user input along another of the first portion or the second portion, and controlling the content in response to the user input.

18. The electronic device of claim 17, the content comprising one or more user actuation targets, the one or more processors actuating the one or more user actuation targets in response to the user input.

19. The electronic device of claim 17, the one or more processors further detecting other user input along the one of the first portion or the second portion and controlling the content in response to the other user input.

20. The electronic device of claim 17, further comprising one or more sensors to detect an orientation of the electronic device in three-dimensional space relative to a user, the one or more processors determining whether to present the content on the first portion or the second portion as a function of the orientation of the electronic device in three-dimensional space relative to the user.
